(19) United States
(12) Patent Application Publication
(10) Pub. No.: US 2026/0197075 A1
(43) Pub. Date: Jul. 9, 2026

(54) MODIFIED PSEUDORANDOM BINARY SEQUENCE (PRBS) PATTERN FOR OPTICAL TRANSCEIVER CALIBRATION AND VALIDATION

(71) Applicant: Cisco Technology, Inc., San Jose, CA (US)

(72) Inventors: Tong Shao, Fürth (DE); Andreas Bernhard Bisplinghoff, Forchheim (DE)

(21) Appl. No.: 19/011,804

(22) Filed: Jan. 7, 2025

(51) Int. Cl. H04B 10/079; H04B 10/077

(52) U.S. Cl. CPC H04B 10/079; H04B 10/077

(57) ABSTRACT

In one embodiment, a method includes obtaining a standard pattern for use in testing an optical transmitter, and modifying the standard pattern to create a modified pattern. The modified pattern is provided to the optical transmitter. The method also includes testing the optical transmitter, wherein testing the optical transmitter include implementing the modified pattern and obtaining at least one measurement after implementing the modified pattern.

### TECHNICAL FIELD

The present disclosure relates to optical networks.

### BACKGROUND

Optical networking uses light signals to transmit data through fiberoptic cables. Equipment, e.g., optical transceivers, used in optical networks facilitates the ability to communicate over long distances through the fiberoptic cables. Calibrating and validating the equipment used in optical networks is critical to ensure the efficient operation of the optical networks. Calibrating optical transceivers is time consuming and, as a result, the cost of production of optical transceivers is significantly impacted by the amount of time needed for calibration. For example, extinction ratios, optical modulation amplitude, overshoot, and undershoot associated with an optical transceiver is generally measured during a calibration process using a short stress pattern random quaternary (SSPRQ) pattern, which is time consuming and, hence, expensive.

### BRIEF DESCRIPTION OF THE DRAWINGS

The disclosure will be readily understood by the following detailed description in conjunction with the accompanying drawings in which:

FIG. 1 is a block diagram representation of an optical transceiver.

FIG. 2 is a process flow diagram which illustrates a method of calibrating an optical transmitter of an optical transceiver in accordance with an embodiment.

FIG. 3 is a process flow diagram which illustrates a method of validating an optical transmitter of an optical transceiver in accordance with an embodiment.

FIG. 4 is a process flow diagram which illustrates a method of utilizing a modified pseudorandom binary sequence 13Q (PRBS13Q) pattern in accordance with an embodiment,

FIG. 5 is a process flow diagram which illustrates a method of modifying a PRBS13Q pattern, e.g., step 455 of FIG. 4, in accordance with an embodiment.

FIG. 6A is a diagrammatic representation of a first portion of a PRBS13Q pattern.

FIG. 6B is a diagrammatic representation of a first portion of a PRBS13Q pattern, e.g. first portion of PRBS13Q pattern 660 of FIG. 6A, as modified to replace symbols in accordance with an embodiment.

FIG. 7A is a diagrammatic representation of a second portion of a PRBS13Q pattern.

FIG. 7B is a diagrammatic representation of a second portion of a PRBS13Q pattern, e.g., second portion of PRBS13Q pattern 760 of FIG. 7A, as modified to replace symbols in accordance with an embodiment.

FIG. 8A is a diagrammatic representation of an end portion of a PRBS13Q pattern.

FIG. 8B is a diagrammatic representation of an end portion of a PRBS13Q pattern, e.g., end portion of PRBS13Q pattern 860 of FIG. 8A, as modified to include an extra symbol in accordance with an embodiment.

FIG. 9 is a block diagram representation of a system that generates a modified PRBS13Q pattern in accordance with an embodiment.

FIG. 10 is a hardware block diagram of a networking/computing device/apparatus/appliance/endpoint that may perform functions associated with any combination of operations in connection with the techniques described with respect to FIGS. 1-5, 6A, 6B, 7A, 7B, 8A, 8B, and 9.

### DETAILED DESCRIPTION

### Overview

Techniques are presented herein that enable optical transceivers to be efficiently calibrated and validated. By providing a test or data pattern that is shorter than a standardized long pattern, but provides estimates of measured parameters that are similar to those associated with the standardized long pattern, the amount of time needed to calibrate and to validate optical transceivers may be reduced. As a result, the efficiency of calibrating and validating optical transceivers may be improved, and the cost of calibrating and validating optical transceivers may be reduced. For example, by implementing a modified pseudorandom binary sequence 13Q (PRBS13Q) pattern for calibration and validation purposes with respect to an optical transceiver rather than a standard short stress pattern random quartenary (SSPRQ) based pattern, the measurement accuracy typically associated with a SSPRQ based pattern may be achieved with a substantially shorter measurement time.

According to one aspect, a method includes obtaining a standard pattern for use in testing an optical transmitter, and modifying the standard pattern to create a modified pattern. The modified pattern is provided to the optical transmitter. The method also includes testing the optical transmitter, wherein testing the optical transmitter includes implementing the modified pattern and obtaining at least one measurement after implementing the modified pattern.

In accordance with another aspect, one or more non-transitory computer readable storage media are encoded with instructions that, when executed by a processor, cause the processor to perform obtaining a standard pattern for use in testing an optical transmitter, modifying the standard pattern to create a modified pattern, and providing the modified pattern to the optical transmitter. The optical transmitter is tested. Testing the optical transmitter includes implementing the modified pattern and obtaining at least one measurement after implementing the modified pattern.

In accordance with still another aspect, one or more non-transitory computer readable storage media are encoded with instructions that, when executed by a processor, cause the processor to perform obtaining a standard pattern for use in testing an optical transmitter. The processor is also caused to perform modifying the standard pattern to create a modified pattern, providing the modified pattern to the optical transmitter, and testing the optical transmitter, wherein testing the optical transmitter includes implementing the modified pattern and obtaining at least one measurement after implementing the modified pattern.

### Example Embodiments

To calibrate and/or to validate optical transceivers, or optical transmitters included in optical transceivers, parameters associated with the optical transceivers may be measured. The parameters may typically include, but are not limited to including, an extinction ratio (ER), an optical modulation amplitude (OMA), an overshoot associated with the OMA, and an undershoot associated with the OMA. As will be appreciated by those skilled in the art, the ER is a measure of the quality of an optical signal, or a measure of efficiency with which available laser power is converted to modulation power, e.g., a modulation depth. The OMA is a measurement of a strength of modulation power. The overshoot and the undershoot may generally be associated with the OMA.

Parameters of an optical transceiver may generally be measured using a test pattern or test data sequence such as a short stress pattern random quartenary (SSPRQ) based pattern. While the use of a SSPRQ pattern is effective in testing, e.g., calibrating and/or validating, an optical transceiver, a SSPRQ pattern generally contains 65,535 four-level pulse-amplitude modulation (PAM4) symbols. As such, taking measurements during tests using a SSPRQ pattern is time-consuming. For example, each measurement cycle taken using a SSPRQ pattern may have a duration on the order of approximately five seconds. Because measurements are typically repeated for different data rates and/or different temperatures, the duration of calibration and validation processes is generally significant and, therefore, expensive.

By using a modified pseudorandom binary sequence (PRBS) pattern or binary code for calibration and validation purposes, the measurement accuracy typically associated with a SSPRQ based pattern may be substantially achieved with a substantially shorter measurement time. As a result, the duration of calibration and validation processes may be reduced, and the efficiency with which calibration and validation processes may be performed is improved, substantially without a significant impact on accuracy. In one embodiment, a PRBS 13Q (PRBS13Q) pattern may be modified and used to calibrate and to validate an optical transceiver. For example, a PRBS13Q pattern may generally include 8191 symbols, while modified PRBS13Q pattern may include 8192 symbols and may replace some symbols generally included in a PRBS13Q pattern.

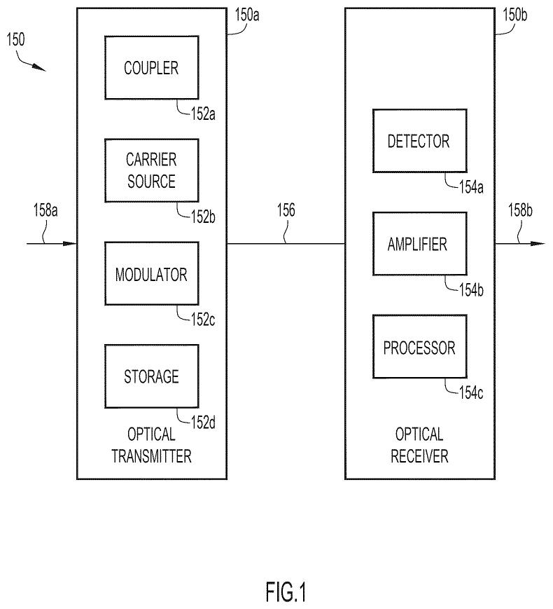

Referring initially to FIG. 1, an optical transceiver will be described. An optical transceiver 150 includes an optical transmitter 150a and an optical receiver 150b. Optical transmitter generally includes a coupler 152a, a carrier source 152b, a modulator 152c, and a storage 152d. Optical receiver 150b generally includes a detector 154a, an amplifier 154b, and a processor 154c. Optical transmitter 150a and optical receiver 150b are in communication over an information channel 156. Information channel 156 may generally be an optical fiber, and may include a repeater and/or an amplifier.

Optical transmitter 150a obtains an input message 158a, or input data, and effectively converts input message 158a into pulses of light that are transmitted across information channel 156 to optical receiver 150b. Data contained in input message 158a may include, but is not limited to including, text, audio, and video data. Optical receiver 150b may convert the pulses of light into an output message 158b.

Modulator 152c may obtain input message 158a and convert message 158a into a format that may be processed by carrier source 152b. Carrier source 152b may generate a carrier wave, e.g., from a modulated light beam created by modulator 152c, that effectively contains the data included in input message 158a. Coupler 152a may provide power to information channel 156, and may cause the carrier wave to be provided to information channel 156. Information channel 156 includes a plurality of lanes or paths on which the carrier wave, or data contained in the carrier wave, may be carried from optical transmitter 150a to optical receiver 150b.

Storage 152d is arranged to store data that may be used for calibration and/or validation purposes. Storage 152d may be any suitable storage arrangement such as, for example, a programmable play-RAM and/or an ASIC ROM.

Detector 154a detects the carrier wave, or data contained in the carrier wave. The data detected by detector 154a is provided to amplifier 154b which amplifies the data. The amplified data is then provided to processor 154c which processes the data to create output message 158b in a suitable format, or a format that may be used by an endpoint (not shown) that is in communication with optical transceiver 150. For example, when input message 158a includes video data, output message 158b may include video data.

To substantially ensure that optical transceiver 150 may meet performance expectations, optical transceiver 150 may be calibrated and/or validated. The calibration and/or validation processes may generally include measuring parameters including, but not limited to including, ER, OMA, overshoot, and undershoot. Optical transmitter 150a and optical receiver 150b may cooperate to obtain measurements associated with parameters, as for example using detector 154a and processor 154c.

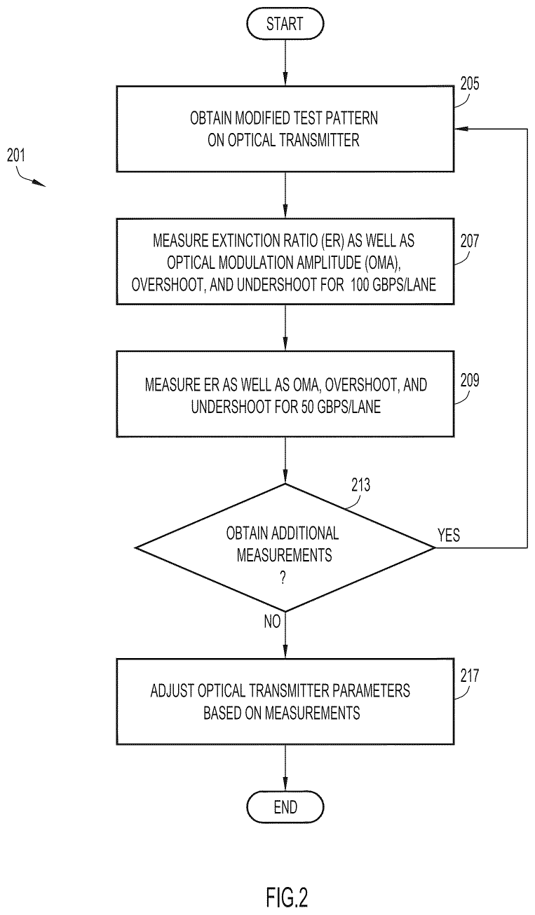

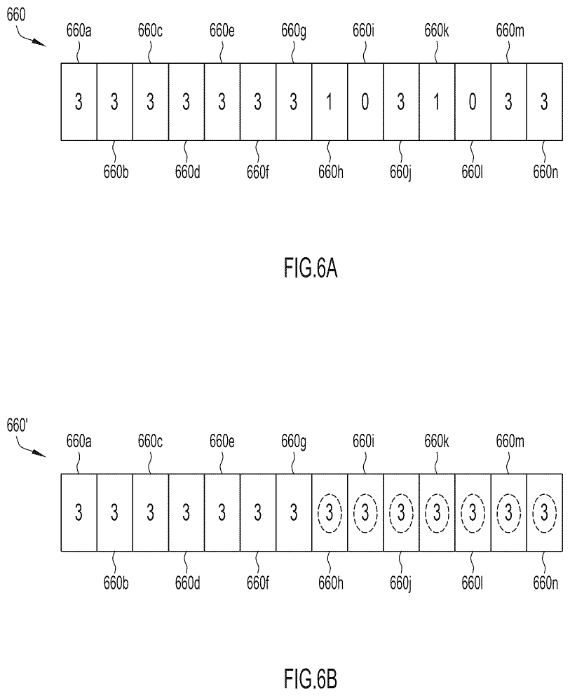

With reference to FIG. 2, a method of calibrating an optical transmitter of an optical transceiver will be described in accordance with an embodiment. A method 201 of calibrating an optical transmitter begins at a step 205 in which a modified test pattern is obtained on the optical transmitter. The modified test pattern may be, in one embodiment, a modified PRBS13Q pattern. One suitable modified PRBS13Q pattern will be discussed below with respect to FIGS. 6A, 6B, 7A, 7B, 8A, and 8B.

In a step 207, an ER, an OMA, an overshoot, and an undershoot are measured for a first channel, as for example by an optical receiver that is in communication with the optical transmitter. In one embodiment, the first channel is a 100 gigabyte per second (gbps) per lane (gbps/lane). Any suitable method may be used to measure the ER, OMA, overshoot, and undershoot. It should be appreciated that the measurements may be taken any number of times.

Once the ER, OMA, overshoot, and undershoot are measured for the 100 gbps/lane, the ER, OMA, overshoot, and undershoot are measured for a 50 gbps/lane in a step 209. It should be appreciated that the measurements may be repeated, and that although a 100 gb data rate and a 50 gb data rate are described, substantially all data rates are supported. That is, supported data rates that are measured in step 207 and step 209 may vary, and are not limited to being 100 gb and 50 gb data rates. From step 209, process flow moves to a step 213 in which it is determined whether additional measurements are to be obtained. If it is determined that additional measurements are to be obtained, process flow returns to a step 205 in which a modified pattern is obtained on an optical transmitter.

Alternatively, if the determination in step 213 is that additional measurements are to be obtained, e.g., are not needed, then parameters related to the optical transmitter are adjusted in a step 217 based on the obtained measurements. That is, if substantially all measurements have been completed, then parameters may be adjusted to desired levels or values based on the measurements. After the optical transmitter parameters are adjusted, the method of calibrating an optical transmitter is completed.

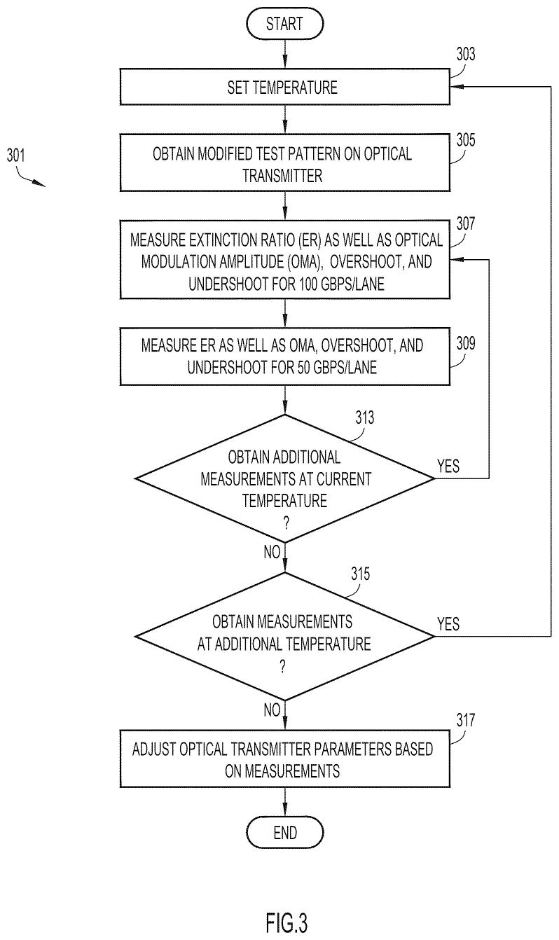

An optical transceiver may be deployed at a location at which environmental factors, e.g., temperatures, may have an effect on the performance of the optical transceiver. Thus, a validation process for an optical transmitter of an optical transceiver may involve accounting for environmental factors, as for example by effectively calibrating the optical transmitter at different temperatures. FIG. 3 is a process flow diagram which illustrates a method of validating an optical transmitter of an optical transceiver in accordance with an embodiment. A method 301 of validating an optical transmitter begins at a step 303 in which a temperature is set. Setting the temperature may include selecting a particular temperature at which to obtain measurements associated with the optical transmitter.

After the temperature is set, a modified test pattern is obtained by the optical transmitter in a step 305. The ER, OMA, overshoot, and undershoot are then measured for a 100 gbps/lane in a step 307. Once the ER, OMA, overshoot, and undershoot are measured for a 100 gbps/lane, the ER, OA, overshoot, and undershoot are measured for a 50 gbps/lane in a step 309. As mentioned above, supported data rates which are measured are not limited to being 100 gb and 50 gb, as substantially all supported data rates may effectively be measured.

A determination is made in a step 313 as to whether additional measurements are to be obtained at the current temperature. If it is determined that additional measurements are to be obtained at the current temperature, then process flow returns to step 307 in which the ER, OMA, overshoot, and undershoot are measured for the 100 gbps/lane.

Alternatively, if it is determined in step 313 that no additional measurements are to be obtained at the current temperature, it is determined in a step 315 whether measurements are to be obtained at an additional temperature. If the determination is that measurements are to be obtained at an additional temperature, process flow returns to step 303 in which the temperature is set to a new temperature.

On the other hand, if the determination in step 315 is that measurements at an additional temperature are not needed, one or more parameters of the optical transmitter may be adjusted in a step 317. For example, the parameters of the optical transmitter may be adjusted to be within a desired range. Upon adjusting the parameters, the method of validating an optical transmitter is completed.

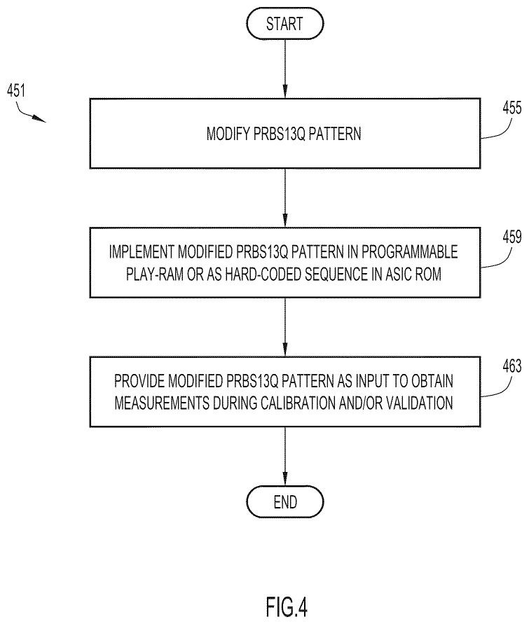

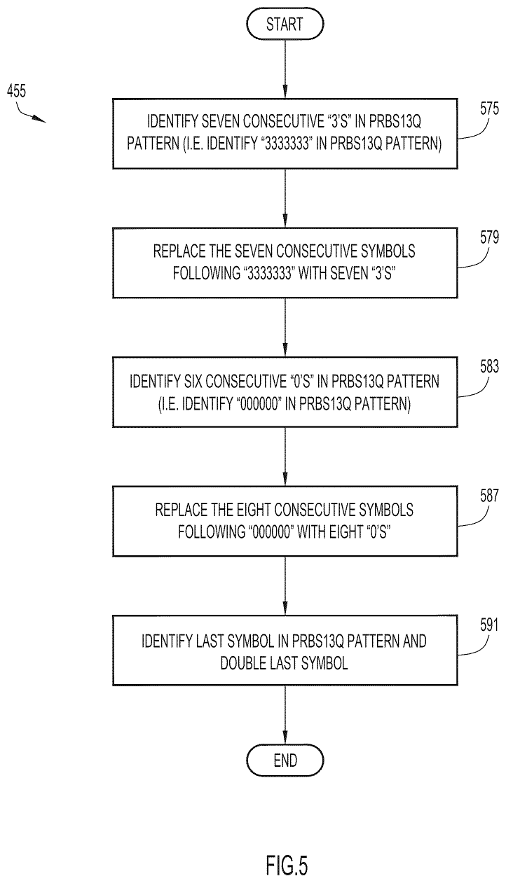

As previously mentioned, a modified test pattern may be a modified PRBS13Q pattern. In one embodiment, the modified PRBS13Q pattern may include symbols which replace symbols that are typically included in a PRBS13Q pattern, and may further include at least one extra symbol. FIG. 4 is a process flow diagram which illustrates a method of utilizing a modified PRBS13Q pattern to obtain measurements from an optical transmitter included in an optical transceiver in accordance with an embodiment. A method 451 of utilizing a modified PRBS13Q pattern begins at a step 455 in which a PRBS13Q pattern is modified. Steps associated with one method of modifying a PRBS13Q pattern will be discussed below with respect to FIG. 5.

After the PRBS13Q pattern is modified, the modified PRBS13Q pattern is implemented in a step 459. Implementing the modified PRBS13Q pattern may include, but is not limited to including, implemented and/or otherwise storing the modifier PRBS13Q pattern in either a programmable play-RAM or as a hard-coded sequence in an ASIC ROM of the optical transmitter.

Once the modified PRBS13Q pattern is implemented, the modified PRBS13Q pattern is provided as input to obtain measurements during a calibration and/or validation process in a step 463. Upon providing the modified PRBS13Q pattern as input, the method of utilizing a modified PRBS13Q pattern is completed.

As will be understood by those skilled in the art, a standard PRBS13Q pattern includes at least one instance of seven consecutive “3” symbols and at least one instance of six consecutive “0” symbols that have an associated level three waveform and an associated level zero waveform, respectively. In one embodiment, creating a modified PRBS13Q pattern may include identifying an instance of seven consecutive “3” symbols and identifying an instance of six consecutive “0” symbols. In one embodiment, modifying a PRBS13Q pattern to include more consecutive “3” symbols and more consecutive “0” symbols increases the efficiency with which calibration and validation of an optical transmitter may be performed while providing increased performance over the performance achieved using a standard PRBS13Q pattern. Further, a modified PRBS13Q pattern enables a waveform associated with level three and level zero to be better aligned with the waveform obtained using a standard SSPRQ pattern.

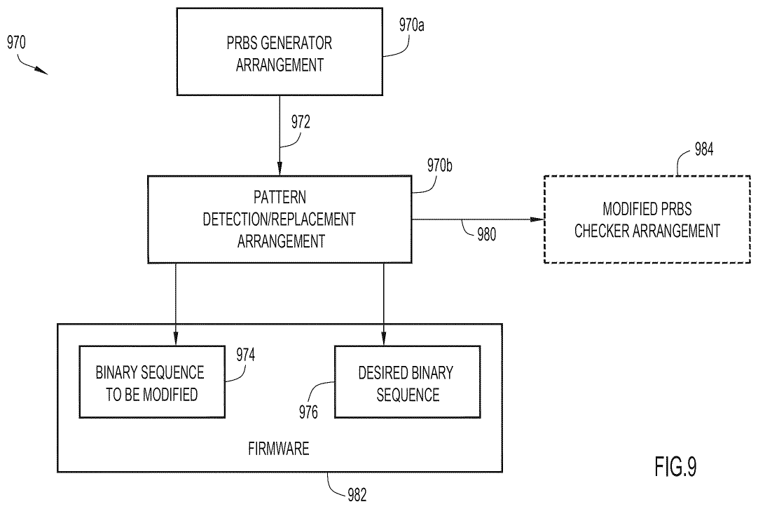

Referring next to FIG. 5, one method of modifying a PRBS13Q pattern, e.g., step 455 of FIG. 4, will be described in accordance with an embodiment. A method or step 455 of modifying a PRBS13Q pattern begins at a step 575 in which seven consecutive “3” symbols are identified in a PRBS13Q pattern. That is, a location in a PRBS13Q pattern which includes a “3333333” pattern or sequence is identified. As will be discussed below with respect to FIG. 9, a pattern detection/replacement arrangement may identify the seven consecutive “3” symbols.

Once seven consecutive “3” symbols are identified in the PRBS13Q pattern, the seven consecutive symbols following the seven consecutive “3” symbols are replaced or overwritten with a desired sequence in a step 579, e.g., by a pattern detection/replacement arrangement. In one embodiment, the desired binary sequence is seven consecutive “3” symbols. In other words, the seven symbols in the PRBS13Q pattern that substantially immediately follow the “3333333” pattern identified in step 575 are effectively removed from the PRBS13Q pattern and replaced with “3” symbols. As a result, a sequence of “33333333333333” is essentially formed.

In a step 583, six consecutive “0” symbols are identified in the PRBS13Q pattern, i.e. a sequence or pattern of “000000” is identified in the PRBS13Q pattern. The eight consecutive symbols in the PRBS13Q pattern that follow the six consecutive “0” symbols are replaced by a desired binary sequence, as for example eight consecutive “0” symbols in a step 587. As a result, a sequence of fourteen consecutive “0” symbols, or “00000000000000,” is essentially formed.

From step 587, process flow moves to a step 591 in which a last symbol in the PRBS13Q pattern is identified and doubled. Doubling the last symbol may generally include copying the last symbol, and appending or otherwise adding the copied last symbol to the end of the PRBS13Q pattern. As a modified PRBS13Q includes the extra symbol, the modified PRBS13Q is one symbol longer than the PRBS13Q pattern. Upon copying the last symbol and adding the copied last symbol to the PRBS13Q pattern, the method of creating a modified PRBS13Q pattern is completed. It should be appreciated that the modified PRBS13Q pattern includes at least one “33333333333333” sequence, at least one “00000000000000” pattern, and an extra end symbol that is the same as the immediately preceding symbol. The extra end symbol in a modified PRBS13Q pattern is generally arranged to facilitate the ease of use of a RAM which typically has a width which may be a power of two, e.g., 64 bit or 128 bit.

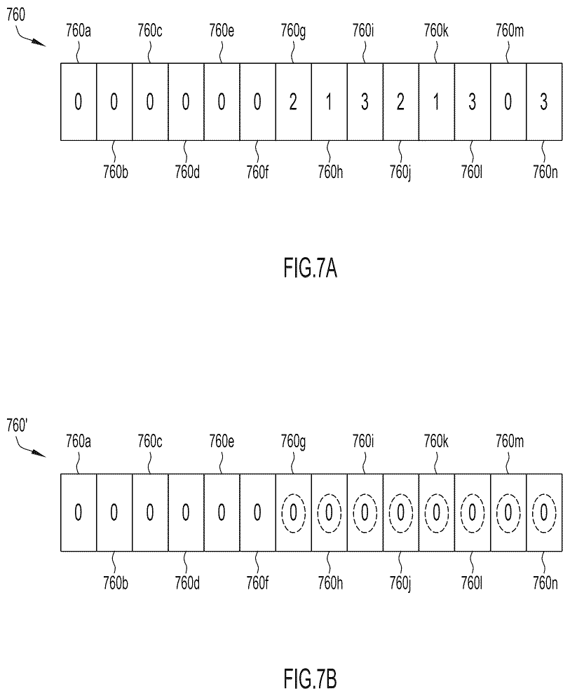

The replacement of symbols in a standard PRBS13Q pattern as part of a process of creating a modified PRBS13Q pattern that facilitates the efficient calibration and/or validation of an optical transmitter will be described with reference to FIGS. 6A, 6B, 7A, and 7B.

FIG. 6A is a diagrammatic representation of a first portion of a PRBS13Q pattern. A portion 660 of a standard PRBS13Q pattern may generally be located substantially anywhere between a first symbol and a last symbol of the PRBS13Q. Portion 660 includes symbol positions 660a-n that each contain a symbol. As shown, portion 660 includes “3” symbols in symbol positions 660a-g. That is, symbol position 660a contains a “3,” symbol position 660b contains a “3,” symbol position 660c contains a “3,” symbol position 660d contains a “3,” symbol position 660e contains a “3,” symbol position 660f contains a “3,” and symbol position 660g contains a “3.”

Symbol positions 660h-n substantially immediately follow symbol positions 660a-g in portion 660. As previously mentioned, the symbols contained or otherwise positioned in symbol positions 660h-n may be replaced in a modified PRBS13Q pattern. FIG. 6B is a diagrammatic representation of first portion 660 of PRBS13Q pattern of FIG. 6A, as modified to replace symbols contained in symbol positions 660h-n in accordance with an embodiment. Within modified portion 660′, “3” symbols are contained in symbol positions 660h-n. In other words, the symbols included in symbol positions 660h-n in portion 660 of FIG. 6A are replaced by “3” symbols in portion 660′. As such, symbol position 660h contains a “3,” symbol position 660i contains a “3,” symbol position 660j contains a “3,” symbol position 660k contains a “3,” symbol position 660l contains a “3,” symbol position 660m contains a “3,” and symbol position 660n contains a “3.” It should be appreciated that in the event that a symbol position 660h-n already contains a “3” in first portion 660 of FIG. 6A, e.g., symbol position 660j contains a “3” in portion 660, the symbol may either be replaced or may remain substantially unaltered.

FIG. 7A is a diagrammatic representation of a second portion of a PRBS13Q pattern. A portion 760 of a standard PRBS13Q pattern may generally be located substantially anywhere between a first symbol and a last symbol of the PRBS13Q. Portion 760 includes symbol positions 760a-n that each contain a symbol. As shown, portion 760 includes “0” symbols in symbol positions 760a-f. That is, symbol position 760a contains a “0,” symbol position 760b contains a “0,” symbol position 760c contains a “0,” symbol position 760d contains a “0,” symbol position 760e contains a “0,” and symbol position 760f contains a “0.”

Symbol positions 760g-n substantially immediately follow symbol positions 760a-f in portion 760. The replacement of symbols in symbol positions 760g-n creates a modified portion. FIG. 7B is a representation of a modified version or portion 760 in accordance with an embodiment. Modified portion 760′ is configured such that substantially all symbol positions 760a-n contain “0” symbols. The symbols included in symbol positions 760g-n in portion 760 of FIG. 7A are replaced by “0” symbols in portion 760'. In other words, within modified portion 760′, symbol position 760g contains a “0,” symbol position 760h contains a “0,” symbol position 760i contains a “0,” symbol position 760j contains a “0,” symbol position 760k contains a “0,” symbol position 760 l contains a “0,” symbol position 760m contains a “0,” and symbol position 760n contains a “0.” For any symbol position 760g-n that contains a “0” in first portion 760 of FIG. 7A, e.g., symbol position 760m contains a “0” in portion 760, the symbol may either be replaced or may remain substantially unchanged.

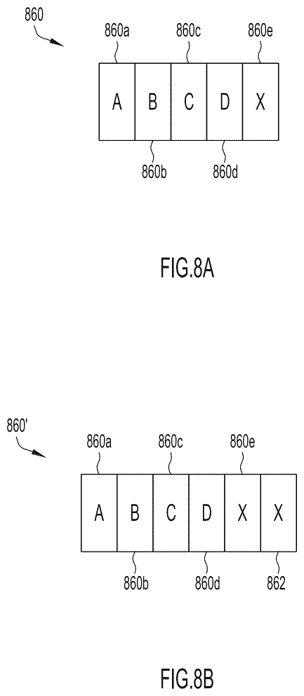

As mentioned above with respect to FIG. 5, a modified PRBS13Q pattern may include an extra symbol or character, as for example at the end of the modified PRBS13Q pattern. FIG. 8A is a diagrammatic representation of an end portion of a PRBS13Q pattern. An end portion 860 of a PRBS13Q pattern may generally include final symbol positions 860a, 860b, 860c, 860d, and 860e in an overall PRBS13Q pattern. As shown, an ending or last symbol position 860e includes a symbol “X.” It should be understood that symbol “X” represents any suitable symbol.

To create a modified version or portion 860, the symbol in last symbol position 860e may be substantially duplicated or otherwise copied, and appended to portion 860 in a new or extra symbol position, as shown in FIG. 8B. A modified portion 860′ includes an additional symbol position 862 appended after last symbol position 860e. Symbol “X,” which is contained in last symbol position 860e, is effectively doubled and contained in additional symbol position 862. In one embodiment, additional symbol position 862 may be the last symbol position in an overall modified PRBS13Q pattern. By way of example, symbol “X” contained in additional symbol position 862 may be symbol number 8192, or the 8192nd symbol, in an overall modified PRBS13Q pattern.

A modified PRBS13Q pattern may generally be generated within an optical transceiver, as for example by an optical transmitter of an optical transceiver. That is, an optical transmitter may generally be configured to create a modified PRBS13Q pattern. An optical receiver of the optical transceiver may be arranged to detect a modified PRBS13Q pattern. FIG. 9 is a block diagram representation of a system that generates a modified PRBS13Q pattern in accordance with an embodiment. A system 970, which may be implemented with respect to an optical transceiver, includes a PRBS generator arrangement 970a and a pattern detection/replacement arrangement 970b. PRBS generator arrangement 970a is configured to generate a PRBS pattern 972 which may be provided to pattern detection/replacement arrangement 970b.

Pattern detection/replacement arrangement 970b is configured to obtain PRBS pattern 972, a binary sequence to be modified 974, and a desired binary sequence 976 as input. Using the obtained input, pattern detection/replacement arrangement 970b may generate a modified PRBS pattern 980. In one embodiment, modified PRBS pattern 980 is a modified PRBS13Q pattern. Binary sequence to be modified 974 and desired binary sequence 976 may be configured in firmware 982. In one embodiment, firmware 982 is located on an optical transmitter. Binary sequence to be modified 974 may generally include information which identifies symbols in PRBS pattern 972 that are to be replaced, and desired binary sequence 976 may generally identify the symbols which are to replace symbols in PRBS pattern 972.

Modified PRBS pattern 980 may be provided to, or otherwise obtained by, a modified PRBS checker arrangement 984. Typically, PRBS checker arrangement 984 is included on an optical receiver, and arranged to detect modified PRBS pattern 980.

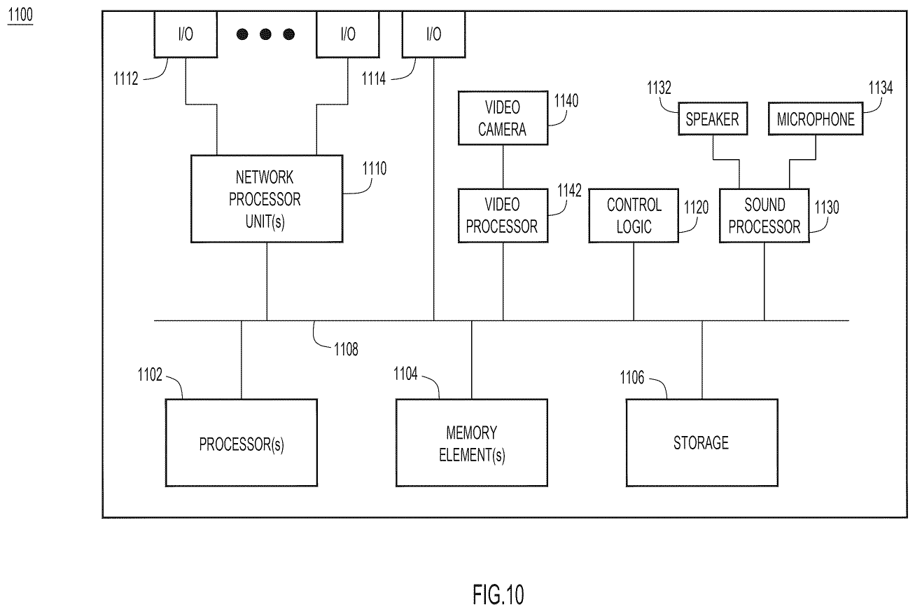

FIG. 10 is a hardware block diagram of a networking/computing device/apparatus/appliance/endpoint that may perform functions associated with any combination of operations in connection with the techniques described with respect to FIGS. 1-5, 6A, 6B, 7A, 7B, 8A, 8B, and 9. It should be appreciated that FIG. 10 provides only an illustration of one example embodiment and does not imply any limitations with regard to the environments in which different example embodiments may be implemented. Many modifications to the depicted environment may be made.

In at least one embodiment, the computing device 1100 may be any apparatus that may include one or more processor(s) 1102, one or more memory element(s) 1104, storage 1106, a bus 1108, one or more network processor unit(s) 1110 interconnected with one or more network input/output (I/O) interface(s) 1112, one or more I/O interface(s) 1114, and control logic 1120. In various embodiments, instructions associated with logic for computing device 1100 may overlap in any manner and are not limited to the specific allocation of instructions and/or operations described herein.

In at least one embodiment, processor(s) 1102 is/are at least one hardware processor configured to execute various tasks, operations and/or functions for device 1100 as described herein according to software and/or instructions configured for device 1100. Processor(s) 1102 (e.g., a hardware processor) may execute any type of instructions associated with data to achieve the operations detailed herein. In one example, processor(s) 1102 may transform an element or an article (e.g., data, information) from one state or thing to another state or thing. Any of potential processing elements, microprocessors, digital signal processor, baseband signal processor, modem, PHY, controllers, systems, managers, logic, and/or machines described herein may be construed as being encompassed within the broad term ‘processor’.

In at least one embodiment, one or more memory element(s) 1104 and/or storage 1106 is/are configured to store data, information, software, and/or instructions associated with device 1100, and/or logic configured for memory element(s) 1104 and/or storage 1106. For example, any logic described herein (e.g., control logic 1120) may, in various embodiments, be stored for device 1100 using any combination of memory element(s) 1104 and/or storage 1106. Note that in some embodiments, storage 1106 may be consolidated with one or more memory elements 1104 (or vice versa), or may overlap/exist in any other suitable manner. In one or more example embodiments, process data is also stored in the one or more memory elements 1104 for later evaluation and/or process optimization.

In at least one embodiment, bus 1108 may be configured as an interface that enables one or more elements of device 1100 to communicate in order to exchange information and/or data. Bus 1108 may be implemented with any architecture designed for passing control, data and/or information between processors, memory elements/storage, peripheral devices, and/or any other hardware and/or software components that may be configured for device 1100. In at least one embodiment, bus 1108 may be implemented as a fast kernel-hosted interconnect, potentially using shared memory between processes (e.g., logic), which may enable efficient communication paths between the processes.

In various embodiments, network processor unit(s) 1110 may enable communication between computing device 1100 and other systems, entities, etc., via network I/O interface(s) 1112 (wired and/or wireless) to facilitate operations discussed for various embodiments described herein. In various embodiments, network processor unit(s) 1110 may be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1100 and other systems, entities, etc. to facilitate operations for various embodiments described herein. In various embodiments, network I/O interface(s) 1112 may be configured as one or more Ethernet port(s), Fibre Channel ports, any other I/O port(s), and/or antenna(s)/antenna array(s) now known or hereafter developed. Thus, the network processor unit(s) 1110 and/or network I/O interface(s) 1112 may include suitable interfaces for receiving, transmitting, and/or otherwise communicating data and/or information in a network environment.

I/O interface(s) 1114 allow for input and output of data and/or information with other entities that may be connected to device 1100. For example, I/O interface(s) 1114 may provide a connection to external devices such as a keyboard, keypad, a touch screen, and/or any other suitable input device now known or hereafter developed. In some instances, external devices may also include portable computer readable (non-transitory) storage media such as database systems, thumb drives, portable optical or magnetic disks, and memory cards.

In various embodiments, control logic 1120 may include instructions that, when executed, cause processor(s) 1102 to perform operations, which may include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1120) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In the even the device 1100 is an endpoint (such as telephone, mobile phone, desk phone, conference endpoint, etc.), then the device 1100 may further include a sound processor 1130, a speaker 1132 that plays out audio and a microphone 1134 that detects audio. The sound processor 1130 may be a sound accelerator card or other similar audio processor that may be based on one or more ASICs and associated digital-to-analog and analog-to-digital circuitry to convert signals between the analog domain and digital domain. In some forms, the sound processor 1130 may include one or more digital signal processors (DSPs) and be configured to perform some or all of the operations of the techniques presented herein. The device 1100 may further include a video camera 1140 and a video processor 1142.

Although only a few embodiments have been described in this disclosure, it should be understood that the disclosure may be embodied in many other specific forms without departing from the spirit or the scope of the present disclosure. By way of example, measurements of parameters have been described as being obtained for a 100 gbps/lane and a 50 gbps/lane. It should be understood that the measurements of parameters are not limited to being obtained from a 100 gbps/lane and a 50 gbps/lane.

The modifications made to a PRBS13Q patterns are not limited to those described above. That is, the symbols which replace symbols in a substantially standard PRBS13Q pattern to create a modified pattern are not limited to the symbols described above. Fewer or additional replacements may be made. For example, a greater number of consecutive zeros and/or ones may effectively be injected into a standard PRBS patterns to substantially match ER and OMA measurements with higher order PRBS sequences. Further, the number of additional symbols added to a standard PRBS13Q pattern to create a modified pattern may vary. For instance, although adding a single symbol at the end of a PRBS13Q pattern has been described, more than one symbol may be added to a PRBS13Q pattern without departing from the spirit or the scope of the present disclosure,

In one embodiment, when a new modified pattern is generated or derived from a standard PRBS pattern, adjustments may be made to increase the measurement accuracy of the new modified pattern. By way of example, if a new modified pattern, or a proposed pattern, has a relatively small residual systematic offset with respect to a standard SSPRQ pattern, the size of the systematic offset may be improved by aligning additional symbols around consecutive threes and/or consecutive zeroes.

The steps included in the methods described above may vary without departing from the spirit or the scope of the disclosure. In general, the steps associated with the methods described above are not limited to being performed in the order indicated. For example, steps relating to the adjustment of optical transmitter parameters may occur either before, or after determining whether additional measures are to be performed. If should be appreciated that a calibration process may be an iterative process and, hence, an additional measurement may be obtained after parameters are adjusted.

The methods described above are generally applicable for any suitable modulation format. Suitable modulation formats include, but are not limited to including, non-return-to-zero (NRZ), PAM4, etc. As will be understood by those skilled in the art, NRZ encodes a binary pattern into a series of substantially fixed voltage levels between approximately zero volts and approximately one volt, and PAM4 utilizes four signal levels with each signal level corresponding to a two-bit symbol.

In some aspects, the techniques described herein relate to a method including: obtaining a standard pattern for use in testing an optical transmitter; modifying the standard pattern to create a modified pattern; providing the modified pattern to the optical transmitter; and testing the optical transmitter, wherein testing the optical transmitter includes implementing the modified pattern and obtaining at least one measurement after implementing the modified pattern.

In some aspects, the techniques described herein relate to a method wherein testing the optical transmitter includes at least one selected from a group including calibrating the optical transmitter and validating the optical transmitter, and wherein the at least one measurement is at least one selected from a group including an extinction ratio, an optical modulation amplitude, an overshoot, and an undershoot.

In some aspects, the techniques described herein relate to a method wherein the standard pattern includes at least a first symbol, and wherein modifying the standard pattern to create the modified pattern includes replacing the at least first symbol with at least a second symbol.

In some aspects, the techniques described herein relate to a method wherein the standard pattern is a pseudorandom binary sequence (PRBS) pattern.

In some aspects, the techniques described herein relate to a method further including: identifying a first plurality of consecutive “3” symbols in the standard pattern; identifying a first plurality of symbols after the first plurality of consecutive “3” symbols; identifying a first plurality of consecutive “0” symbols in the standard pattern; and identifying a second plurality of symbols after the first plurality of consecutive “0” symbols, wherein modifying the standard pattern to create the modified pattern includes replacing the first plurality of symbols with a second plurality of consecutive “3” symbols and replacing the second plurality of symbols with a second plurality of consecutive “0” symbols.

In some aspects, the techniques described herein relate to a method wherein the first plurality of consecutive “3” symbols includes approximately seven “3” symbols, the first plurality of consecutive “0” symbols includes approximately six “0” symbols, the second plurality of consecutive “3” symbols includes approximately seven “3” symbols, and the second plurality of consecutive “0” symbols includes approximately eight “0” symbols.

In some aspects, the techniques described herein relate to a method wherein the standard pattern includes a last symbol at an end of the standard pattern, and wherein modifying the standard pattern to create the modified pattern includes duplicating the last symbol to create a duplicated last symbol and appending the duplicated last symbol to the end.

In some aspects, the techniques described herein relate to an apparatus including: one or more network processor units to communicate with devices in a network; and a processor coupled to the one or more network processor units and configured to perform: obtaining a standard pattern for use in testing an optical transmitter; modifying the standard pattern to create a modified pattern; providing the modified pattern to the optical transmitter; and testing the optical transmitter, wherein testing the optical transmitter includes implementing the modified pattern and obtaining at least one measurement after implementing the modified pattern.

In some aspects, the techniques described herein relate to an apparatus wherein testing the optical transmitter includes at least one selected from a group including calibrating the optical transmitter and validating the optical transmitter, and wherein the at least one measurement is at least one selected from a group including an extinction ratio, an optical modulation amplitude, an overshoot, and an undershoot.

In some aspects, the techniques described herein relate to an apparatus wherein the standard pattern includes at least a first symbol, and wherein modifying the standard pattern to create the modified pattern includes replacing the at least first symbol with at least a second symbol.

In some aspects, the techniques described herein relate to an apparatus wherein the standard pattern is a pseudorandom binary sequence (PRBS) pattern.

In some aspects, the techniques described herein relate to an apparatus wherein the processor is further configured to perform: identifying a first plurality of consecutive “3” symbols in the standard pattern; identifying a first plurality of symbols after the first plurality of consecutive “3” symbols; identifying a first plurality of consecutive “0” symbols in the standard pattern; and identifying a second plurality of symbols after the first plurality of consecutive “0” symbols, wherein modifying the standard pattern to create the modified pattern includes replacing the first plurality of symbols with a second plurality of consecutive “3” symbols and replacing the second plurality of symbols with a second plurality of consecutive “0” symbols.

In some aspects, the techniques described herein relate to an apparatus wherein the first plurality of consecutive “3” symbols includes approximately seven “3” symbols, the first plurality of consecutive “0” symbols includes approximately six “0” symbols, the second plurality of consecutive “3” symbols includes approximately seven “3” symbols, and the second plurality of consecutive “0” symbols includes approximately eight “0” symbols.

In some aspects, the techniques described herein relate to one or more non-transitory computer readable storage media encoded with instructions that, when executed by a processor, cause the processor to perform: obtaining a standard pattern for use in testing an optical transmitter; modifying the standard pattern to create a modified pattern; providing the modified pattern to the optical transmitter; and testing the optical transmitter, wherein testing the optical transmitter includes implementing the modified pattern and obtaining at least one measurement after implementing the modified pattern.

In some aspects, the techniques described herein relate to one or more non-transitory computer readable storage media wherein testing the optical transmitter includes at least one selected from a group including calibrating the optical transmitter and validating the optical transmitter, and wherein the at least one measurement is at least one selected from a group including an extinction ratio, an optical modulation amplitude, an overshoot, and an undershoot.

In some aspects, the techniques described herein relate to one or more non-transitory computer readable storage media wherein the standard pattern includes at least a first symbol, and wherein modifying the standard pattern to create the modified pattern includes replacing the at least first symbol with at least a second symbol.

In some aspects, the techniques described herein relate to one or more non-transitory computer readable storage media wherein the standard pattern is a pseudorandom binary sequence (PRBS) pattern.

In some aspects, the techniques described herein relate to one or more non-transitory computer readable storage media further including instructions that, when executed by a processor, cause the processor to perform: identifying a first plurality of consecutive “3” symbols in the standard pattern; identifying a first plurality of symbols after the first plurality of consecutive “3” symbols; identifying a first plurality of consecutive “0” symbols in the standard pattern; and identifying a second plurality of symbols after the first plurality of consecutive “0” symbols, wherein modifying the standard pattern to create the modified pattern includes replacing the first plurality of symbols with a second plurality of consecutive “3” symbols and replacing the second plurality of symbols with a second plurality of consecutive “0” symbols.

In some aspects, the techniques described herein relate to one or more non-transitory computer readable storage media wherein the first plurality of consecutive “3” symbols includes approximately seven “3” symbols, the first plurality of consecutive “0” symbols includes approximately six “0” symbols, the second plurality of consecutive “3” symbols includes approximately seven “3” symbols, and the second plurality of consecutive “0” symbols includes approximately eight “0” symbols.

In some aspects, the techniques described herein relate to one or more non-transitory computer readable storage media wherein the standard pattern includes a last symbol at an end of the standard pattern, and wherein modifying the standard pattern to create the modified pattern includes duplicating the last symbol to create a duplicated last symbol and appending the duplicated last symbol to the end.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which may be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1106 and/or memory elements(s) 1104 may store data, software, code, instructions (e.g., processor instructions), logic, parameters, combinations thereof, and/or the like used for operations described herein. This includes the storage 1106 and/or memory elements(s) 1104 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4 ) and/or IP version 6 (IPv6 ) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to convey that the property value may be within +/−5%, within +/−4%, within +/−3%, within +/−2%, within +/−1%, or even closer, of the given value.

Similarly, when a given feature is described as being “substantially parallel” to another feature, “generally perpendicular” to another feature, and so forth, this is intended to convey that the given feature is within +/−5%, within +/−4%, within +/−3%, within +/−2%, within +/−1%, or even closer, to having the described nature, such as being parallel to another feature, being perpendicular to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining a standard pattern for use in testing an optical transmitter;
modifying the standard pattern to create a modified pattern;
providing the modified pattern to the optical transmitter; and
testing the optical transmitter, wherein testing the optical transmitter includes implementing the modified pattern and obtaining at least one measurement after implementing the modified pattern.

2. The method of claim 1 wherein testing the optical transmitter includes at least one selected from a group including calibrating the optical transmitter and validating the optical transmitter, and wherein the at least one measurement is at least one selected from a group including an extinction ratio, an optical modulation amplitude, an overshoot, and an undershoot.

3. The method of claim 1 wherein the standard pattern includes at least a first symbol, and wherein modifying the standard pattern to create the modified pattern includes replacing the at least first symbol with at least a second symbol.

4. The method of claim 1 wherein the standard pattern is a pseudorandom binary sequence (PRBS) pattern.

5. The method of claim 4 further including:
identifying a first plurality of consecutive “3” symbols in the standard pattern;
identifying a first plurality of symbols after the first plurality of consecutive “3” symbols;
identifying a first plurality of consecutive “0” symbols in the standard pattern; and
identifying a second plurality of symbols after the first plurality of consecutive “0” symbols, wherein modifying the standard pattern to create the modified pattern includes replacing the first plurality of symbols with a second plurality of consecutive “3” symbols and replacing the second plurality of symbols with a second plurality of consecutive “0” symbols.

6. The method of claim 5 wherein the first plurality of consecutive “3” symbols includes approximately seven “3” symbols, the first plurality of consecutive “0” symbols includes approximately six “0” symbols, the second plurality of consecutive “3” symbols includes approximately seven “3” symbols, and the second plurality of consecutive “0” symbols includes approximately eight “0” symbols.

7. The method of claim 6 wherein the standard pattern includes a last symbol at an end of the standard pattern, and wherein modifying the standard pattern to create the modified pattern includes duplicating the last symbol to create a duplicated last symbol and appending the duplicated last symbol to the end.

8. An apparatus comprising:
one or more network processor units to communicate with devices in a network; and
a processor coupled to the one or more network processor units and configured to perform:
obtaining a standard pattern for use in testing an optical transmitter;
modifying the standard pattern to create a modified pattern;
providing the modified pattern to the optical transmitter; and
testing the optical transmitter, wherein testing the optical transmitter includes implementing the modified pattern and obtaining at least one measurement after implementing the modified pattern.

9. The apparatus of claim 8 wherein testing the optical transmitter includes at least one selected from a group including calibrating the optical transmitter and validating the optical transmitter, and wherein the at least one measurement is at least one selected from a group including an extinction ratio, an optical modulation amplitude, an overshoot, and an undershoot.

10. The apparatus of claim 8 wherein the standard pattern includes at least a first symbol, and wherein modifying the standard pattern to create the modified pattern includes replacing the at least first symbol with at least a second symbol.

11. The apparatus of claim 8 wherein the standard pattern is a pseudorandom binary sequence (PRBS) pattern.

12. The apparatus of claim 11 wherein the processor is further configured to perform:
identifying a first plurality of consecutive “3” symbols in the standard pattern;
identifying a first plurality of symbols after the first plurality of consecutive “3” symbols;
identifying a first plurality of consecutive “0” symbols in the standard pattern; and
identifying a second plurality of symbols after the first plurality of consecutive “0” symbols, wherein modifying the standard pattern to create the modified pattern includes replacing the first plurality of symbols with a second plurality of consecutive “3” symbols and replacing the second plurality of symbols with a second plurality of consecutive “0” symbols.

13. The apparatus of claim 12 wherein the first plurality of consecutive “3” symbols includes approximately seven “3” symbols, the first plurality of consecutive “0” symbols includes approximately six “0” symbols, the second plurality of consecutive “3” symbols includes approximately seven “3” symbols, and the second plurality of consecutive “0” symbols includes approximately eight “0” symbols.

14. One or more non-transitory computer readable storage media encoded with instructions that, when executed by a processor, cause the processor to perform:
obtaining a standard pattern for use in testing an optical transmitter;
modifying the standard pattern to create a modified pattern;
providing the modified pattern to the optical transmitter; and
testing the optical transmitter, wherein testing the optical transmitter includes implementing the modified pattern and obtaining at least one measurement after implementing the modified pattern.

15. The one or more non-transitory computer readable storage media of claim 14 wherein testing the optical transmitter includes at least one selected from a group including calibrating the optical transmitter and validating the optical transmitter, and wherein the at least one measurement is at least one selected from a group including an extinction ratio, an optical modulation amplitude, an overshoot, and an undershoot.

16. The one or more non-transitory computer readable storage media of claim 14 wherein the standard pattern includes at least a first symbol, and wherein modifying the standard pattern to create the modified pattern includes replacing the at least first symbol with at least a second symbol.

17. The one or more non-transitory computer readable storage media of claim 14 wherein the standard pattern is a pseudorandom binary sequence (PRBS) pattern.

18. The one or more non-transitory computer readable storage media of claim 17 further including instructions that, when executed by a processor, cause the processor to perform:
identifying a first plurality of consecutive “3” symbols in the standard pattern;
identifying a first plurality of symbols after the first plurality of consecutive “3” symbols;
identifying a first plurality of consecutive “0” symbols in the standard pattern; and
identifying a second plurality of symbols after the first plurality of consecutive “0” symbols, wherein modifying the standard pattern to create the modified pattern includes replacing the first plurality of symbols with a second plurality of consecutive “3” symbols and replacing the second plurality of symbols with a second plurality of consecutive “0” symbols.

19. The one or more non-transitory computer readable storage media of claim 18 wherein the first plurality of consecutive “3” symbols includes approximately seven “3” symbols, the first plurality of consecutive “0” symbols includes approximately six “0” symbols, the second plurality of consecutive “3” symbols includes approximately seven “3” symbols, and the second plurality of consecutive “0” symbols includes approximately eight “0” symbols.

20. The one or more non-transitory computer readable storage media of claim 19 wherein the standard pattern includes a last symbol at an end of the standard pattern, and wherein modifying the standard pattern to create the modified pattern includes duplicating the last symbol to create a duplicated last symbol and appending the duplicated last symbol to the end.
